(19) United States
(12) Patent Application Publication
(10) Pub. No.: US 2009/0233609 A1
(43) Pub. Date: Sep. 17, 2009

(54) Touchless Plug and Play Base Station

(75) Inventors: Edwin Vai Hou Iun, Kanata (CA); Steve Baillargeon, Gatineau (CA)

Correspondence Address: NORTEL NETWORKS LIMITED, 5601 GRANITE PARKWAY, SUITE 750, PLANO, TX, 75024, US

(73) Assignee: Nortel Networks Limited, St. Laurent (CA)

(21) Appl. No.: 12/337,462

(22) Filed: Dec. 17, 2008

Related U.S. Application Data
(60) Provisional application No. 61/035,832, filed on Mar. 12, 2008.

(51) Int. Cl. H04W 40/00

(52) U.S. Cl. 455/445

(57) ABSTRACT

Included is an access network comprising at least one access node, a dynamic host configuration protocol (DHCP) server coupled to the access node, a network attached storage (NAS) coupled to the access node, a network element manager (NEM) coupled to the access node, and a common provisioning system (CPS) coupled to the access node, wherein the access node is configured for initial network connectivity and initial startup configuration in a substantially automated manner. Also included is a touchless installation method comprising initiating network connectivity for a base transceiver station (BTS) without manual operations, and initiating start-up configuration for the BTS without manual operations.

### CROSS-REFERENCE TO RELATED APPLICATIONS

The present disclosure is related to and claims the priority of U.S. Provisional Patent application No. 61/035,832, entitled “Touchless Plug and Play BTS,” by Edwin Vai Hou lun et al., filed Mar. 12, 2008, which is incorporated by reference herein for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

In wireless cellular telecommunications systems, transmission and/or receiving systems, such as base transceiver stations (BTSs), transmit signals throughout a geographical region, referred to as a cell, determined by the wireless range of the signals. Such systems are typically constructed in compliance with standards promulgated by established standards bodies, such as the Third Generation Partnership Project (3GPP) and 3GPP2. More advanced network access standards, such as 3GPP's Long Term Evolution (LTE), have been introduced recently to provide improved and/or new services. As is well understood in the field of telecommunications, installation of existing and advanced networks involves complicated manual installation steps of BTSs, also referred to as “enhanced node B” (ENB) for some systems, performed by trained technicians or engineers. Such steps may include connecting a personal computer (PC) to an equipment port of each BTS, and launching a tool to set up the BTS configuration parameters, which requires a certain level of expertise, up-to-date toolsets, and preloading the PC with configuration parameters. Alternatively, the installation can be implemented using a configuration server, which requires dedicated software and hardware. This current installation strategy may incur acceptable cost when only a limited number of equipment is deployed. However, as demand for such equipment is scaled upwardly to serve large (or densely populated) geographic regions, the cost associated with the foregoing installation practices becomes burdensome to the network operator, and can negatively impact the timing and/or extent of BTS deployment.

### SUMMARY OF THE INVENTION

In one embodiment, the disclosure includes an access network comprising at least one access node, a dynamic host configuration protocol (DHCP) server coupled to the access node, a network attached storage (NAS) coupled to the access node, a network element manager (NEM) coupled to the access node, and a common provisioning system (CPS) coupled to the access node, wherein the access node is configured for initial network connectivity and initial startup configuration in a substantially automated manner.

In another embodiment, the disclosure includes a touchless installation method comprising initiating network connectivity for a BTS (e.g. an ENB) without manual operations, and initiating start-up configuration for the BTS (e.g. an ENB) without manual operations.

In yet another embodiment, the disclosure includes a method comprising connecting a BTS to a network, establishing communications between the BTS and at least one configuration server in the network, and accessing a repository in the network whenever the BTS or the configuration server requires configuration information to complete automatic set-up of the BTS.

Other aspects and features of the present invention will become apparent to those of ordinary skill in the radio communications art upon review of the following description of specific embodiments of the invention in conjunction with the accompanying figures.

### BRIEF DESCRIPTION OF THE DRAWINGS

FIG. 1 is an illustration of an access network according to an embodiment of the disclosure.

FIG. 2 is a block diagram of a touchless installation method according to an embodiment of the disclosure.

FIG. 3 is a message sequence diagram of touchless installation communications according to an embodiment of the disclosure.

FIG. 4 is an illustration of an embodiment of a general-purpose computer system according to an embodiment of the disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

Disclosed herein is a system and method for installing a BTS, ENB, or similar network access node in a substantially touchless manner in the absence of participation of trained technicians. Specifically, the touchless approach comprises initiating network connectivity between the access node and a network comprising a plurality of components, including a storage component or a server. Hence, the access node may obtain from the storage component or the server a plurality of configuration parameters, which may be used for its initial start-up configuration, in a predetermined or automated manner with little or no input from a user. Accordingly, the access node may be automatically configured based on a default configuration or based on neighbor access node configurations. The access node configuration may be automatically amended or upgraded based on site-specific parameters and/or may be automatically authenticated and managed by the network or a network component before initiating communications via a network access gateway.

When the number of deployed equipment is increased, such as anticipated for deploying home or local BTSs, existing installation practices, which involve in many instances on-site manual provisioning, become less cost efficient and desirable. In contrast, a self-operating BTS installation as described herein is expected to significantly reduce the time, manpower, and actual cost associated with deployment of a large BTS network.

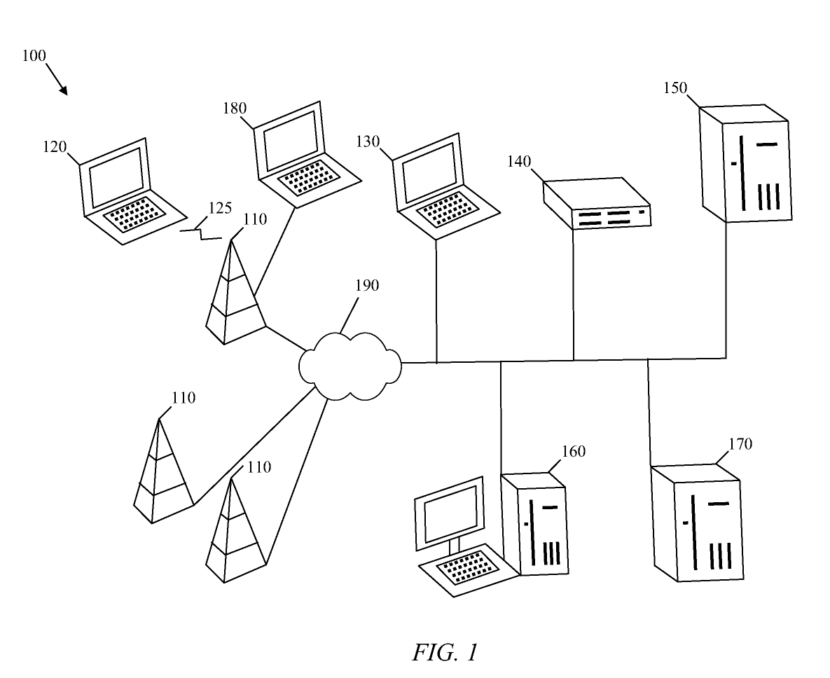

FIG. 1 illustrates one embodiment of an access network 100 in accordance with this disclosure. The access network 100 may be a wireless communication network, such as an LTE access network. The access network 100 may comprise at least one access node 110, at least one user element 120, a Common Provisioning System (CPS) 130, a DHCP server 140, a Network Attached Storage (NAS) 150, a Network Element Manager (NEM) 160, a software distribution site (SDS) 170, and a management PC 180. The access network 100 may comprise a transport network 190 conforming to any of a plurality of telecommunications standards or initiatives, such as an IP routed network including Multiprotocol Label Switching (MPLS), an Ethernet switched network including Virtual Local Area Network (VLAN) bridging, Institute of Electrical and Electronics Engineers (IEEE) 802.1 Q-in-Q VLAN Tag (QinQ), Provider Backbone Transport (PBT), or Provider Link State Bridging (PLSB).

The access node 110 and the user element 120 may be connected via a wireless link 125 and may communicate via the wireless link 125, for instance using radio transmission equipment. In an embodiment, the access node 110 may be a BTS in the form of a macro BTS of the type adapted to support cellular communications in a network over a large geographic area, such as specified by the 3GPP and 3GPP2 standards. The BTS may be located at a specific on-site location of the access network 100 and provide wireless communications or coverage to a prescribed coverage area or a public area, such as a cell. Alternatively, the access node 110 may be in the form of a micro BTS, which may be located at a local site or may be nomadic. The micro BTS may provide wireless communications with limited functionality, e.g., limited capability for network directed handoff to another BTS or to a private area. Examples of micro BTSs include femtocells located in a home or office building, which may provide wireless communications to a relatively small coverage area in comparison to a macro BTS. Although there are three access nodes 110 shown in the figure, the wireless communication system 100 may comprise any number of access nodes 110, which may be configured similarly or differently. Further, the access nodes 110 may be connected via a wireless link to at least one user element 120 or to any other network component or network.

The wireless link may conform to any of a plurality of telecommunications standards or initiatives, such as those described in the 3rd Generation Partnership Project (3GPP), including Global System for Mobile communications (GSM), General Packet Radio Service (GPRS)/Enhanced Data rates for Global Evolution (EDGE), High Speed Packet Access (HSPA), Universal Mobile Telecommunications System (UMTS), and Long Term Evolution (LTE). Additionally or alternatively, the wireless link may conform to any of a plurality of standards described in the 3rd Generation Partnership Project 2 (3GPP2 ), including Interim Standard 95 (IS-95), Code Division Multiple Access (CDMA) 2000 standards 1xRTT, 1xEV-DO, or Ultra Mobile Broadband (UMB). The wireless link may also be compatible with other standards, such as those described by the IEEE, or other industry forums, such as the Worldwide Interoperability for Microwave Access (WiMAX) forum.

The user element 120 may be located within the prescribed coverage area of the access node 110. Although only one user element 120 is shown in the figure, the wireless communication system 100 may also comprise any number of user elements 120, which may be configured similarly or differently. The user element 120 may be any device capable of transmitting or receiving a signal, such as an analog or digital signal, to and from the access node 110, using a wireless technology. The user element 120 may be a mobile device configured to create, send, or receive signals, such as a handset, a personal digital assistant (PDA), a cell phone (also referred to as a “mobile terminal”), internet and/or e-mail equipped “smart phone,” or a wireless-enabled nomadic or roaming device, such as a laptop computer. Alternatively, the user element 120 may be a fixed device, such as a desktop computer, or a set top box, which may send or receive data to the access node 110.

The CPS 130 may be used for the configuration or amendment of the access node 110 using planning tool information. For instance, the CPS 130 may be used to process network information using dedicated tools or applications to obtain network configuration parameters, such as radio parameters, which may be suitable for the operation of the access node 110. The DHCP server 140 may be configured to allocate a specific address for the access node 110 and may distribute a plurality of additional network information about the connectivity to the NAS 150 within the Operations, Administration, and Maintenance (OAM) network and other network equipment, such as Security Gateway (SEG), within the access network 100. Hence, the access node 110 may use the allocated address to establish initial connectivity. The NAS 150 may comprise the network information including initial or standard configuration for the access node 110. Additionally, the NAS 150 may comprise operation management (OM) information including statistics about the operations or performances of various components or devices of the access network 100. The NEM 160 may host at least one optimization application, such as Nortel's Self-Optimizing Network (SON) optimization application. The optimization application may comprise a plurality of optimization and configuration applications including optimization applications for planning, advanced network monitoring, fault detection, reporting, and workflow automation. The SDS 170 may be a centralized software load repository, which may be used to download and update software at other components including the access node 110. The management PC 180 may be coupled to the access node and may host a Web Browser tool to access at least some of the other components, including the access node 110.

The access node 110 may communicate, directly or indirectly, with at least some of the components described above, which may in turn communicate with some of the remaining components. In an embodiment, the access node 110 may be connected to at least some or all the components above via an established transport network, such as VLAN. Further, each of components above may be located on a separate server that provides the functionality of the component. Alternatively, at least some of the components above may be combined into a single server, which may provide the combined functionalities of its individual components.

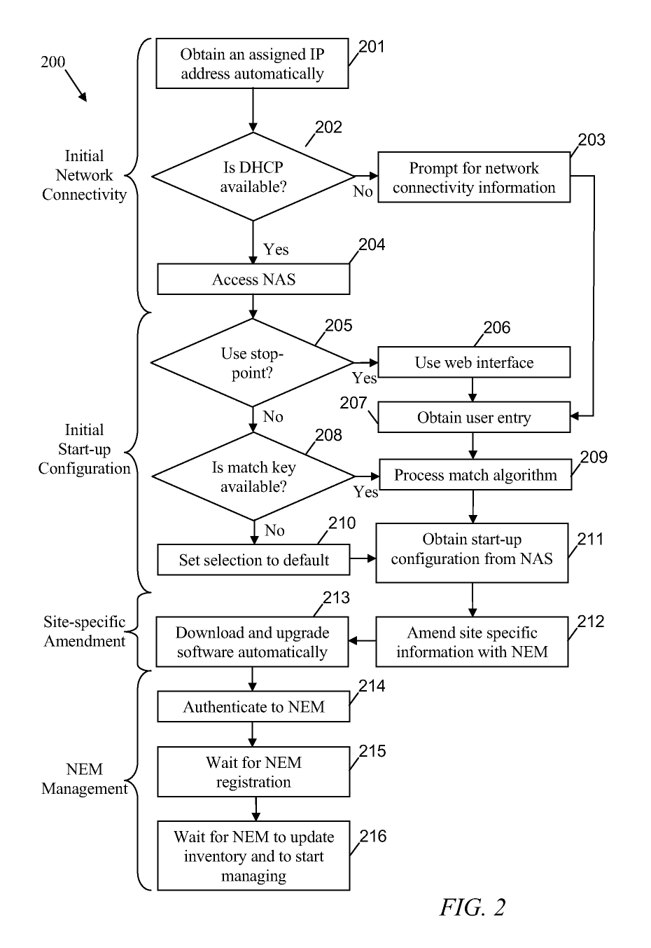

FIG. 2 illustrates one embodiment of a touchless installation method 200 in accordance with this disclosure. The touchless installation method 200 may be implemented in a network, such as the access network 100, to install a BTS or any other access node 110 in the network in an automated manner without substantial manual configuration. The access node 110, for example a BTS, may be connected to at least some of the remaining network components including components that comprise the required configuration information, components that are configured to handle at least some part of the automated installation process, or both. As such, the automated installation of the access node 110 may be achieved as a result of the combination of functionalities between the various components.

Specifically, the touchless installation method 200 may establish first initial network connectivity for the access node 110. The access node 110 may be inserted with some or all of the factory pre-configured information, such as access node unique identifier (ID) and security identity. In an embodiment, at block 201, the touchless installation method 200 may request an assigned network address for the access node 110, such as an Internet Protocol (IP) address. For instance, the access node 110 may be connected or plugged to a network, such as a VLAN, and hence send, via the VLAN, a request for an IP address to a DHCP server 140. The request may comprise authentication information or credentials, such as a factory set vendor class identifier. The touchless installation method 200 may proceed to block 202, where the touchless installation method 200 may verify whether the DHCP server 140 is available for IP address allocation and for distribution of other network connectivity information. The touchless installation method 200 may proceed to block 204 if DHCP service is available. Otherwise, the touchless installation method 200 may proceed to block 203 to query or request further instruction via the management PC 180. At block 204, the touchless installation method 200 may access or connect to the NAS 150, after receiving the IP address assigned by the DHCP server 140, and hence proceed to block 205. For instance, the DHCP server 140 may receive the request for IP address from the access node 110, authenticate the access node 110 based on the authentication information, assign an IP address to the access node 110 from an IP address pool, and send the IP address to the access node 110. The DHCP server 140 may also send some or all of the network information such as NAS 150 IP address, NAS 150 Fully Qualified Domain Name (FQDN), SEG IP address or SEG FQDN. In an embodiment, the DHCP response may include the assigned IP address and may include in its vendor specific information field or in an option field the network information. Alternatively, at block 203, when DHCP service is not available, the access node 110 may request or prompt for network connectivity information from the management PC 180, which may require some manual feedback, as described below. Accordingly, the touchless installation method 200 may proceed to block 207.

Next, the touchless installation method 200 may begin initial start-up configuration. At block 205, the touchless installation method 200 may verify whether auto (e.g. touchless) or manual initial start-up behavior is desired or requested. For instance, the touchless installation method 200 may obtain a stop-point profile to determine the initial start-up behavior. The stop-point profile may comprise at least one stop-point and may be stored in the NAS 150. The touchless installation method 200 may proceed to block 208 if auto or touchless behavior is determined. Otherwise, the touchless installation method 200 may proceed to block 206. At block 206, the touchless installation method 200 may use a web interface to provide a limited degree of manual installation behavior, such as a one touch manual overwrite installation procedure. In other embodiments, the web interface may be substituted by any other interface that provides a means to enter a unique ID, which may be any ASCII based string, a password, a hardware serial number, etc. The touchless installation method 200 may then proceed to block 207, where the unique ID may be obtained by user entry. The touchless installation method 200 may then proceed to block 209.

At block 208, the touchless installation method 200 may verify whether a match key that matches the access node 110 with a neighbor or closest neighbor is available, or whether a “seed” or default configuration is available. For instance, the touchless installation method 200 may obtain a match key information stored in the NAS 150, including a unique ID, work order information (e.g. order number, date), hardware type, Global Positioning System (GPS) location, and geographical location (e.g. street address). The touchless installation method 200 may proceed to block 209 if a match key is found. Otherwise, the touchless installation method 200 may proceed to block 210. At block 209, the touchless installation method 200 may process any available match key, for instance from the NAS 150, using a match algorithm locally at the access node 110, or at the CPS 130 or NEM 160 to obtain a suitable or optimized configuration for the access node 110. In an embodiment, the configuration data may include the NEM IP address. The touchless installation method 200 may then proceed to block 211, where start-up configuration for the access node 110 may be obtained from the NAS 150. Alternatively, at block 210, the touchless installation method 200 may use default selection to obtain the configuration for the access node 110. For instance, the seed configuration, which may be obtained from the NAS 150, may be chosen for the access node 110.

Next, the touchless installation method 200 may begin site-specific amendment. At block 212, the touchless installation method 200 may amend site specific information using the NEM 160 and CPS 130. For instance, the access node 110 may send the key information above to the NEM 160, which may determine with the CPS 130 the unique access node 110 ID from the planning tool information. The NEM 160 and CPS 130 may automatically generate radio parameters, Radio Access Network (RAN) information, neighbor list information associated with each access node 110 in the network, other information, or combinations thereof. For instance, the radio parameters may include frequency, transmit power, cabling information, and antenna information. Such parameters and information may be used to configure the access node 110 to operate appropriate operations. The touchless installation method 200 may then proceed to block 213, where the access node 110 may download such information and parameters, for instance by downloading a software patch to update its own software with the new or updated parameter values or information, for instance from an SDS. In an embodiment, the access node 110 may obtain or download the software patch via the SDS or a network. For instance, the access node 110 may be restarted or rebooted with its new OAM and RAN network assignment or configuration. Further, in some embodiments, the access node 110 may be configured to reboot or restart automatically.

Next, the touchless installation method 200 may begin NEM management. At block 214, the access node 110 may authenticate with the NEM 160. For instance, the access node 110 may forward its credential to the NEM 160 or CPS 130. The touchless installation method 200 may then proceed to block 215, where the touchless installation method 200 may wait for the NEM 160 while the NEM 160 registers the access node 110 without monitoring and managing it. Finally, at block 216, the touchless installation method 200 may wait for the NEM 160 to collect inventory information from the access node 110, update its own inventory, and start managing the access node 110 communications with the network.

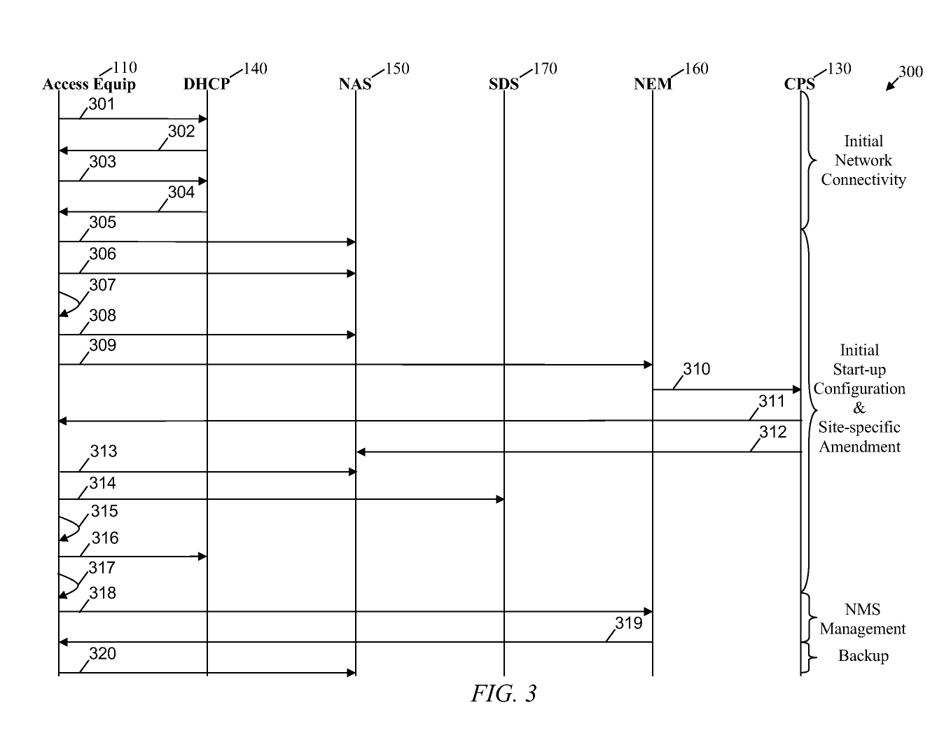

FIG. 3 illustrates one embodiment of touchless installation communications 300 in accordance with this disclosure. The touchless installation communications 300 may be established between the various components described above to provide substantial automatic configuration to the access node 110, which may be a BTS such as an ENB. The substantial automatic configuration may comprise plugging the access node 110 to the network, communicating with a plurality of network servers, and accessing a central repository in the network whenever information are needed from one of the servers to complete the automatic configuration process.

Specifically, the touchless installation communications 300 may comprise communications for the initial network connectivity of the access node 110. Accordingly, the access node 110 may send an address request, such as an OAM DHCP discover message 301, to a DHCP server 140, for instance upon plugging the access node 110 to a network, such as a VLAN, and booting the access node 110. The OAM DHCP discover message 301 may comprise some or all of the ENB identity information such as the unique ID or vendor class identifier, which may be used to authenticate the access node 110 at the DHCP server 140. The DHCP server 140 may send back an assigned address to the access node 110. For instance, the DHCP server 140 may send an OAM DHCP offer message 302, which may also comprise network connectivity information such as a Network Access Server (NAS) IP address, to advertise the assigned IP address to the access node 110. The access node 110 may reply with an OAM DHCP request message 303 to request the advertised address. Hence, the DHCP server 140 may send an OAM DHCP acknowledgement message 304, which may comprise the IP assigned to the access node 110 and network connectivity information, such as the NAS IP address.

Additionally, the touchless installation communications 300 may comprise communications for initial start-up configuration and of the access node 110 and site specific amendment. Accordingly, the access node 110 may initiate a connection to a NAS 150, for instance by sending message 305. Further, in some embodiments, the connection may be initiated using a secure network protocol, such as a secure shell (ssh) or Internet Protocol Security (IPsec). The message 305 may comprise the ENB's credentials, such as the assigned IP address and an authentication key. Once the connection is established between the access node 110 and the NAS 150, the access node 110 may obtain the stop point profile from the NAS 150, for instance by sending a request message 306 to the NAS 150. Further, the access node 110 may obtain its own GPS coordinate or unique identifier (e.g. ID), for instance by receiving a message 307 comprising its own GPS coordinate or from a Web interface. Next, the access node 110 may obtain a match key or the best match key from the NAS 150, for instance by sending a request message 308 to the NAS 150, including its own GPS coordinate or unique identifier. The access node 110 may download from NAS 150 a set of configuration parameters associated with the match key or the best match key.

When the downloading of configuration parameters is completed, as described above, the access node 110 may query site specific amendment from the NEM 160, for instance by sending a request message 309 to the NEM 160, which may be sent using ssh or IPsec. The request message may comprise the ENB's credentials and GPS location. Hence, the NEM 160 may signal the CPS 130 to obtain site specific information for the access node 110 such as the associated radio parameters, RAN information, or neighbor list information. For instance, the NEM 160 may send a request message 310 to the CPS 130 to obtain such information. In turn, the CPS 130 may respond by sending a notifying message 311 to the access node 110, which may comprise the site specific information. Alternatively, the CPS 130 may respond by storing the site specific information at the NAS 150, for instance by sending a message 312 including such information to the NAS 150. The access node 110 may then obtain the information by signaling the NAS 150, for instance using a request message 313. The access node 110 may then reload or update any product software for operation, for instance by sending an update request message 314 to an SDS 170. The access node 110 may then receive the updates including update patches or software downloads, which may be downloaded at 315. Next, the access node 110 may release the assigned IP address, for instance by sending an OAM DHCP release message 316 to the DHCP server 140. After releasing the IP address, the access node 110 may complete software upgrade 317 and reboot.

Further, the touchless installation communications 300 may comprise communications for NEM 160 management. Accordingly, the access node 110 may register with the NEM 160 for management purposes, for instance by sending a registration message 318 to the NEM 160, including its credentials. In response, the NEM 160 may enroll the access node 110 and exchange updated inventory information with the access node 110, for instance using a message 319. Finally, the touchless installation communications 300 may comprise backup communications, including sending a configuration backup from the access node 110 to the NAS 150, for instance using a backup message 320.

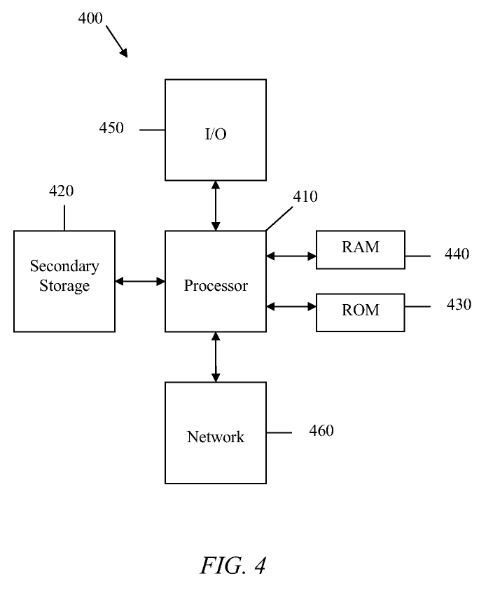

At least some of the system components described above, such as the components of the access network 100, may be implemented on any general-purpose network component, such as a computer or network component with sufficient processing power, memory resources, and network throughput capability to handle the necessary workload placed upon it. FIG. 4 illustrates a typical, general-purpose network component 400 suitable for implementing one or more embodiments of the components disclosed herein. The network component 400 includes a processor 410 (which may be referred to as a central processor unit or CPU) that is in communication with memory devices including secondary storage 420, read only memory (ROM) 430, random access memory (RAM) 440, input/output (I/O) devices 450, and network connectivity devices 460. The processor 410 may be implemented as one or more CPU chips, or may be part of one or more ASICs.

The secondary storage 420 is typically comprised of one or more disk drives or tape drives and is used for non-volatile storage of data and as an over-flow data storage device if RAM 440 is not large enough to hold all working data. Secondary storage 420 may be used to store programs that are loaded into RAM 440 when such programs are selected for execution. The ROM 450 is used to store instructions and perhaps data that are read during program execution. ROM 450 is a non-volatile memory device that typically has a small memory capacity relative to the larger memory capacity of secondary storage 420. The RAM 440 is used to store volatile data and perhaps to store instructions. Access to both ROM 430 and RAM 440 is typically faster than to secondary storage 420.

Additionally, at least some of the system components described herein may be implemented using at least one FPGA and/or ASIC. For instance, at least some of the system components may be implemented using point-by-point methods in one or more FPGAs, instead of using block based methods in a microprocessor. In other embodiments, at least some of the system components may be implemented using an internally integrated CPU or an external CPU chip.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is not required. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. An access network comprising:
at least one access node;
a dynamic host configuration protocol (DHCP) server coupled to the access node;
a network attached storage (NAS) coupled to the access node;
a network element manager (NEM) coupled to the access node; and
a common provisioning system (CPS) coupled to the access node,
wherein the access node is configured for initial network connectivity and initial startup configuration in a substantially automated manner.

2. The access network of claim 1 further comprising a software distribution site (SDS) coupled to the access node.

3. The access network of claim 1, wherein the access node is configured for site-specific amendment and NEM management in a substantially automated manner.

4. The access network of claim 1, wherein the access node is configured similar to a neighbor access node based on a match key.

5. The access network of claim 1, wherein the access node is a base transceiver station (BTS).

6. The access network of claim 1, wherein the access node is located in a fixed geographic position.

7. The access network of claim 1, wherein at least some of the DHCP server, the NAS, the NEM, and the CPS are combined in the access network.

8. The access network of claim 1, wherein the access node, the DHCP server, the NAS, the NEM, and the CPS communicate with one another via an established Virtual Local Area Network (VLAN).

9. A touchless installation method comprising:
initiating network connectivity for a base transceiver station (BTS) without manual operations; and
initiating start-up configuration for the BTS without manual operations.

10. The touchless installation method of claim 9, wherein initiating network connectivity comprises obtaining a dynamically assigned IP address from a dynamic host configuration protocol (DHCP) server.

11. The touchless installation method of claim 9, wherein a BTS identifier is provided manually when DHCP IP address assignment is not provided.

12. The touchless installation method of claim 9, wherein initiating network connectivity comprises obtaining a stop-point profile or touchless profile from a network attached storage (NAS), obtaining an optimized or default configuration for the BTS based on match key from the NAS, and obtaining start-up configuration for the BTS from the NAS.

13. The touchless installation method of claim 9 further comprising:
implementing a site-specific amendment for the BTS without manual operations; and
enabling network element manager (NEM) management without manual operations.

14. The touchless installation method of claim 13, wherein implementing the site-specific amendment comprises amending site-specific information for the BTS using the NEM and a common provisioning system (CPS), downloading and upgrading software from a software distribution site (SDS),

15. The touchless installation method of claim 13, wherein enabling network element manager (NEM) management comprises authenticating the BTS with the NEM, registering the ENB with the NEM, and updating inventory at the NEM.

16. A method comprising:
connecting a base transceiver station (BTS) to a network;
establishing communications between the BTS and at least one configuration server in the network; and
accessing a repository in the network when the BTS or the configuration server requires configuration information to complete automatic set-up of the BTS.

17. The method of claim 16, wherein the configuration server is a dynamic host configuration protocol (DHCP) server, and wherein the communications between the BTS and the DHCP server are established using Operations, Administration, and Maintenance (OAM) DHCP.

18. The method of claim 16, wherein the configuration server is a network attached storage (NAS).

19. The method of claim 18, wherein the configuration information is backed up at the NAS when the automatic set-up of the BTS is complete.

20. The method of claim 16, wherein the configuration server is a network element manager (NEM), and wherein the communications between the BTS and the NEM are established using a secure shell (ssh) protocol or an Internet Protocol Security (IPsec) protocol.
